(19) United States
(12) Patent Application Publication
(10) Pub. No.: US 2005/0219479 A1
(43) Pub. Date: Oct. 6, 2005

(54) Image projection device that is able to float and to fly

(75) Inventor: Rainer Mugrauer, Neckartailfingen (DE)

Correspondence Address: COHEN, PONTANI, LIEBERMAN & PAVANE, 551 FIFTH AVENUE, SUITE 1210, NEW YORK, NY, 10176, US

(73) Assignee: Markus Lenzenhuber and Daniel Peter Lenzenhuber, Seeg (DE)

(21) Appl. No.: 10/521,323

(22) PCT Filed: Jul. 16, 2003
(86) PCT No.: PCT/DE03/02389

§ 371 Date: Apr. 18, 2005

(30) Foreign Application Priority Data
Jul. 16, 2002 (DE) 202 10 790.6
Aug. 8, 2002 (DE) 202 12 316.2

(51) Int. Cl. G03B 21/00

(52) U.S. Cl. 353/122

(57) ABSTRACT

An image projection device that is capable of floating and flying includes a buoyant body having a first outer surface, a second outer surface opposite from the first outer surface, and a buoyancy-free section between the first and second outer surfaces. A projector is arranged at the first outer surface, and a planar projection screen is arranged essentially at the second outer surface, the projector being separated from the projection screen by a projection range which is within the buoyancy-free section. According to another embodiment, there is no buoyancy free section, and the projection screen is fastened to the buoyant body as a separate component in the vicinity of the second outer surface. The buoyant body is configured so that its buoyancy provides stable locations of the projector and the projection surface.

The invention relates to an image projection device capable of hovering and flying having at least a buoyant body, projector, and projection surface of the general types defined under claim 1.

A device of that type is known from German Registered Design DE 201 11 846.7, where a projector is arranged within a balloon filled with a fluid. The image projected by the projector is made visible by projecting it onto the inner surface of the skin of the balloon, which serves as a projection surface. The image will then be visible to viewers from outside the balloon, which may lie on the ground, hover, or ascend.

To be regarded as disadvantageous in the case of that image projection device is that, solely due to the manner in which it is constructed, heat generated in the interior of the balloon by the projector will destabilize the balloon's buoyancy characteristics due to the resultant higher temperatures. Another, fundamental, disadvantage is due to employment of the curved surface of the balloon's skin as a projection surface. Employing that sort of curved surface as a projection surface means that rather elaborate, expensive equipment will be necessary in order to eliminate image distortions.

The problem addressed by the present invention is configuring the known image projection device capable of hovering and flying having a buoyant body, projector, and projection surface such that the aforementioned disadvantages due to the manner in which it is constructed will be avoided, and an inexpensive, and, in terms of the equipment involved, readily mastered, image projection device capable of hovering and flying that will be attractive to viewers will be made available.

### BENEFITS OF THE INVENTION

The image projection device capable of hovering and flying according to the invention and having those characterizing features stated under claims 1 and 8 solves that problem in a beneficial manner. Compared to the state of the art, significant benefits of the device according to the invention are that it employs an essentially planar projection surface that is not part of the skin of the buoyant body, and that its arrangement of the projector essentially outside the buoyant body avoids heating problems. To be generally regarded as another benefit is that the device is configured such that it conserves space when it is not filled with buoyant fluid.

In the case of a first form of an image projection device according to the invention, that is, in principle, achieved by configuring the shape and volume of the buoyant body such that the buoyancy that it is capable of generating provides stable locations of the mutually remotely arranged projector and projection surface corresponding to the projection range, the projector is arranged essentially outside a first outer surface of the buoyant body, the projection surface essentially coincides with a second outer surface of the buoyant body that is situated across from the first outer surface thereof and is essentially planar when in use, and that the buoyant body has a buoyancy-free section situated between the projector and projection surface that does not significantly affect the path of the beam transiting the space between the projector and the projection surface.

In the case of a second form of an image projection system according to the invention, that is, in principle, achieved by configuring the volume of the buoyant body such that the buoyancy that it is capable of generating provides stable locations of the mutually remotely arranged projector and projection surface corresponding to the projection range, the projector is arranged essentially outside a first outer surface of the buoyant body, the projection surface is essentially planar when in use, the projection surface is arranged in the vicinity of a second outer surface of the buoyant body that is situated essentially across from the first outer surface of the buoyant body, and that the projection surface is fastened inside the buoyant body, as a separate component thereof.

Those features stated under the other claims allow beneficial elaborations on, and improvements of, the devices stated under claims 1 and 8.

Under a beneficial embodiment of the first form of the device according to the invention, it is provided that the shape of the buoyancy-free section situated within the space between the projector and the projection surface is configured in the form of an inverted pyramid, in particular, corresponds to that of a cone.

Under another, beneficial embodiment of the first form of the device according to the invention, it is provided that the buoyant body consists of a single component and preferably has an essentially cubical shape.

Under a beneficial embodiment of the first form of the device according to the invention that represents an alternative thereto, it is provided that the buoyant body is formed from two, essentially identical, partial bodies, where those partial bodies are arranged, one above the other, along the buoyancy axis such that they compensate for a nonuniform weight distribution, in the sense of maintaining a stable orientation.

Under another, beneficial configuration of that embodiment of the first form of the device according to the invention, each partial body has an essentially wedge-shaped profile.

In conjunction with another, beneficial configuration, in accordance with a particularly beneficial embodiment example of the basic solution according to the invention, in the case of this alternative embodiment, it is provided that the two, wedge-shaped, partial bodies are joined together by suitable fastening devices such that the outer surface of the resultant assembly has a roughly cubical shape.

In conjunction with another, beneficial configuration of the first form of the invention, the buoyant body of the device is assembled from chambers that are, if necessary, sealed off from one another, and may have differing dimensions in order to obtain the desired final, external shape. That approach provides a particularly elegant, simple, and useful solution that is both favorable and beneficial to adjusting buoyant forces to agree with the existing weight distribution, and also provides for maintenance of the desired shape-stability.

Under another, beneficial configuration of the first form of the device according to the invention, its buoyant body is held floating in place by flexible lines. An additional benefit resulting from a further, useful configuration is due to the fact that controllable driving devices, in particular, driving devices that are controllable by a remote controller, are provided on the buoyant body.

Under beneficial elaborations on those embodiment examples of the invention, it is provided that they are wholly incorporated into aircraft, in particular, blimps or dirigibles, where the aircraft involved may be such that have, preferably, been designed for operation inside buildings and are, preferably, maneuverable under remote control.

Under a first, beneficial configuration of the second form of the device according to the invention, it is provided that the buoyant body has a spherical shape and the projection surface has a shape approximating that of a segment of the surface of a sphere that is arranged within the spherical, buoyant body as a separate component thereof, and is mounted in the beam path, across from the projector. Under a beneficial elaboration on this configuration, the buoyant body is configured such that it is transparent over that section thereof that, when viewed from outside, is situated in front of the projection surface.

Under a second, beneficial configuration of the second form of the device according to the invention, it is provided that the buoyant body is configured in the form of a cylinder, the projector is mounted essentially outside a planar surface of that cylinder, and the projection surface is mounted within that cylinder, as a separate component thereof, and is situated in the beam path, across from the projector, in the vicinity of a second, planar surface of that cylinder that is essentially parallel to the aforementioned, first, planar surface.

Under a beneficial elaboration on that second configuration of the second form of the device according to the invention, the projection surface is incorporated into the associated, essentially planar, outer surface of the buoyant body, as a separate component thereof. The buoyant body may, depending upon the particular embodiment involved, be configured such that it is transparent over that section thereof that, when viewed from outside, is situated in front of the projection surface. Under an alternative solution, the projection surface may also form the entire second, planar surface of the cylinder, or a portion thereof. Since the projection surface would then become part of the buoyant body's skin, no transparent pane or transparent skin section would be necessary.

Under a beneficial elaboration on the second configuration of the second form of the device according to the invention, the cylindrical, buoyant body is configured in the form of either a right circular cylinder or an oblique circular cylinder.

Under a beneficial configuration of either of the two embodiments of the second form of the device according to the invention, the projection surface is welded in place inside the buoyant body.

Under another, beneficial configuration of the second form of the device according to the invention, its buoyant bodies are loosely held in place by flexible lines. An additional benefit resulting from a further, useful configuration is due to the fact that controllable driving devices, in particular, driving devices that are controllable by a remote controller, are provided on the buoyant body.

### FIGURES

FIG. 1 is a schematic perspective view of a first embodiment example of a first form of the invention, as viewed from the front, i.e., facing the projection surface;

FIG. 2 is a schematic perspective view of the first embodiment example of the invention, as viewed from the rear, i.e., from that side thereof where the projector is mounted;

FIG. 3 is a schematic side view of the first embodiment example of the invention;

FIG. 4 is a schematic rear view of the first embodiment example of the invention;

FIG. 5 is a schematic front view of the first embodiment example of the invention;

FIG. 6 is a schematic top view of the first embodiment example of the invention;

FIG. 7 is a schematic perspective view of a second embodiment example of the invention incorporated into a blimp or dirigible serving as the transporting aircraft, shown here as viewed from the front, i.e., facing the projection surface;

FIG. 8 is a schematic sectioned view of the second embodiment example shown in FIG. 7;

FIG. 9 is a schematic side view of a first embodiment example of the second form of the invention, a spherical buoyant body, together with a projector and projection surface;

FIG. 10 is a schematic view of the first embodiment example of the second form of the invention shown in FIG. 9 from the front, i.e., facing the projector;

FIG. 11 is a schematic perspective view of one-half of the first embodiment example of the second form of the invention shown in FIGS. 9 and 10;

FIG. 12 is a schematic side view of a second embodiment example of the second form of the invention, a cylindrical buoyant body, together with a projector and projection surface;

FIG. 13 is a schematic view of the second embodiment example of the second form of the invention shown in FIG. 12 from the front, i.e., facing the projector; and

FIG. 14 is a schematic perspective view of one-half of the second embodiment example of the second form of the invention shown in FIGS. 12 and 13.

### DESCRIPTIONS OF THE EMBODIMENT EXAMPLES

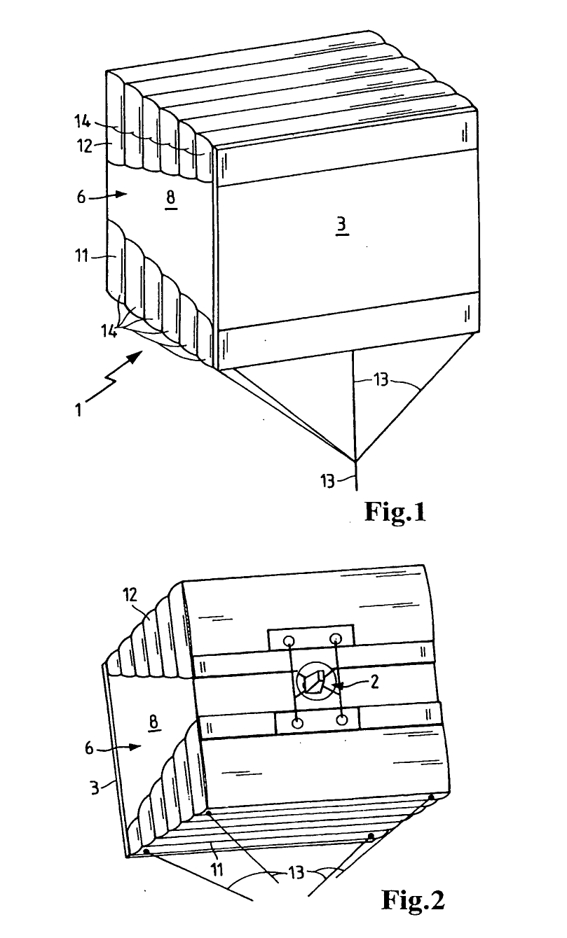

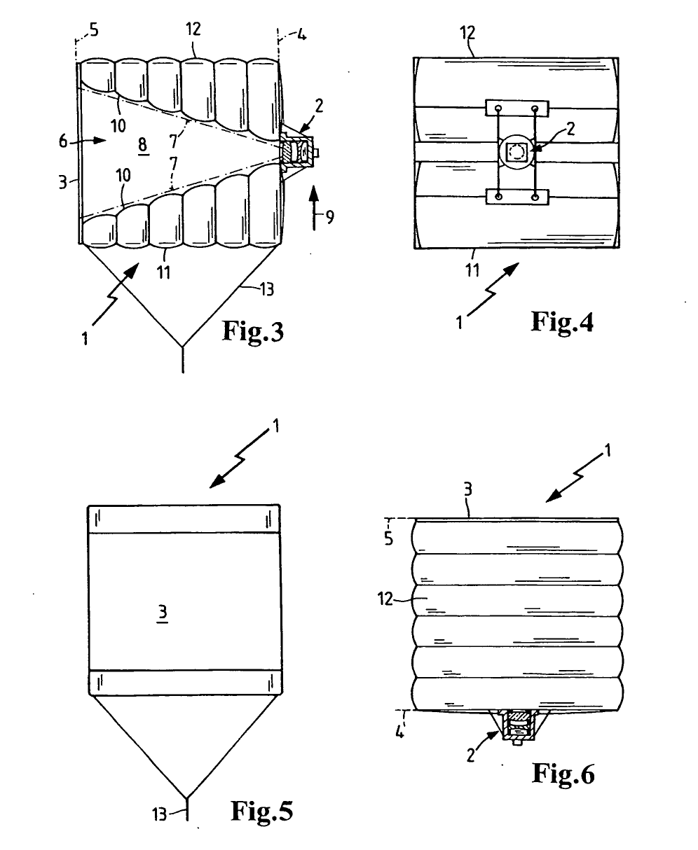

A first embodiment example of the first form of the invention will be described below, based on the various schematic views thereof shown in FIGS. 1-6. FIG. 1 depicts a schematic perspective view of a first embodiment example of the invention, as viewed from the front. The image projection device capable of hovering and flying comprises at least one buoyant body 1, projector 2, and projection surface 3. According to the invention, the shape and volume of the buoyant body 1 are configured such that the buoyancy that it is capable of generating guarantees stable locations of the projector 2 and the projection surface 3, which are mutually remotely arranged at a separation corresponding to the projection range, where the projector 2 is arranged essentially outside a first outer surface 4 of the buoyant body 1 and the projection surface 3 essentially coincides with a second outer surface 5 of the buoyant body 1 that is situated across from the first outer surface 4 and is essentially planar when in use. The buoyant body 1 has a buoyancy-free section 6 situated between the projector 2 and projection surface 3 that does not significantly affect the path 7 of the beam transiting the space 8 between the projector 2 and the projection surface 3, which is indicated by the dotted lines in FIG. 3.

According to the invention, under one embodiment, the shape of the buoyancy-free section 6 situated within the space 8 between the projector 2 and the projection surface 3 may be configured in the form of an inverted pyramid, in particular, may correspond to that of a cone. That option has not been shown in detail in the figure. It will be beneficial if the buoyant body 1 involved consists of a single component and preferably has an essentially cubical shape. The projector 2 is situated at the apex of the pyramid, where its heat-generating components are situated outside the associated outer surface 4 of the cubical buoyant body 1. The projection surface 3 lies in the plane of the pyramid's base, and corresponds to the outer surface 5 appearing in FIG. 3.

Under a beneficial embodiment of the first form of the device according to the invention that represents an alternative thereto, as shown in FIGS. 1-6, the buoyant body 1 is formed from two, essentially identical, partial bodies 11, 12. Those two partial bodies 11, 12 are arranged, one above the other, along the buoyancy axis 9 such that they compensate for a nonuniform weight distribution, in the sense of maintaining a stable orientation. The reason why the configuration of this embodiment of the device according to the invention is particularly beneficial is that the outer surfaces of each of the partial bodies 11, 12 are essentially wedge-shaped. When they are joined together to form the buoyant body 1, whose outer surface may have a cubical shape, their broader ends, which generate more buoyancy, will be arranged in the vicinity of the projector 2, and their thinner ends, which generate less buoyancy, will be arranged in the vicinity of the projection surface 3. The partial bodies 11, 12 are joined together, and the cubical shape of the outer surface of the resultant assembly formed, by means of fastening devices, which have not been shown in detail, situated between the partial bodies 11, 12. The inner, inclined, surfaces 10 of the wedged partial bodies 11, 12 are tilted such that they will not significantly interfere with the path 7 of the beam transiting the space 8 between them. The gap in the lateral, outer surfaces of the buoyant body 1 that define the lateral boundaries of that space 8 and is situated between the outer surfaces 4, 5 may be closed using suitable covers in order to prevent light from escaping laterally, which will provide that the gazes of viewers will not be diverted from the presentation appearing on the projection surface 3, particularly if they are viewing it from off-axis locations. The fastening devices that stabilize the assembly and determine the cubical shape are beneficially provided in the vicinity of those lateral, outer surfaces.

As shown in FIGS. 1-6, the buoyant body 1 is assembled from chambers 14 that are, if necessary, sealed off from one another. They may have differing dimensions in order to obtain the desired final, external shape, as, in particular, has been shown, and is the case, for the partial bodies 11, 12. The configuration of the buoyant body 1 will give it an extremely high shape-stability, particularly when it is inflated, regardless of whether it is in the form of a single component or is assembled from the two partial bodies 11, 12. Depending upon their configuration and shapes, the individual chambers 14 may be inflated with a buoyant fluid, in particular, helium, either singly, in groups, or all at once by means of valves, which have not been shown. The configurations of the chambers 14, partial bodies 11, 12 or the buoyant body 1 as a whole, and the buoyant forces obtainable therefrom are matched to the locations and magnitudes of counteracting forces exerted by weights, in particular, the weights of the projector 2 and projection surface 3, in order to guarantee a balanced, desired, stable positioning of the entire image projection device capable of hovering and flying.

In particular, as shown in FIGS. 1-3 and FIG. 5, the buoyant body 1, and thus the image projection device capable of hovering and flying according to the invention, may be loosely held in place by flexible lines 13. These may be cables anchored to the ground, or anchored to other fixed points within a room, in order to achieve a fixed spatial positioning. The projection surface 3 may thus be simply, and in the desired manner, aligned on viewers and held in place. Alternatively thereto, or in addition thereto, controllable driving devices, in particular, driving devices that are controllable by a remote controller, may be provided on the buoyant body 1. Those devices, which have not been shown in the figures, will allow both relocating and fixing the positions and orientations of projected images.

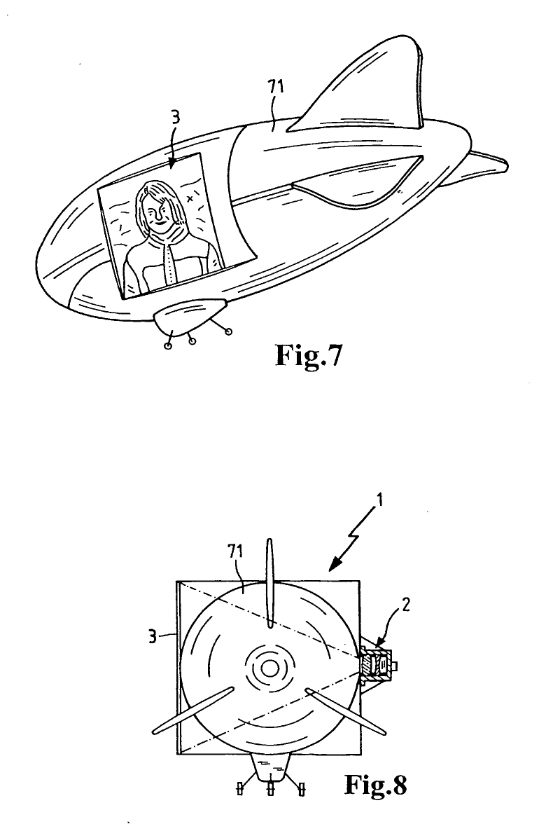

Under beneficial elaborations on these embodiment examples of the invention, it may be provided that they are wholly incorporated into an aircraft, in particular, a blimp or a dirigible, as shown in FIGS. 7 and 8. FIG. 7 depicts a schematic perspective view of this second, essential, embodiment example of the invention, as viewed off-axis from the front, i.e., facing the projection surface 3, installed on the side of a blimp/dirigible 71 employed as the aircraft involved, where that aircraft 71 may, preferably, have been designed for operation inside buildings and, preferably, is maneuverable under remote control. FIG. 8 schematically depicts another view, a sectioned side view, of this second embodiment example of the invention that has been shown in FIG. 7, where the spatial arrangement of the projector 2 and projection surface 3 orthogonal to the longitudinal axis of the blimp/dirigible 71 may be readily recognized.

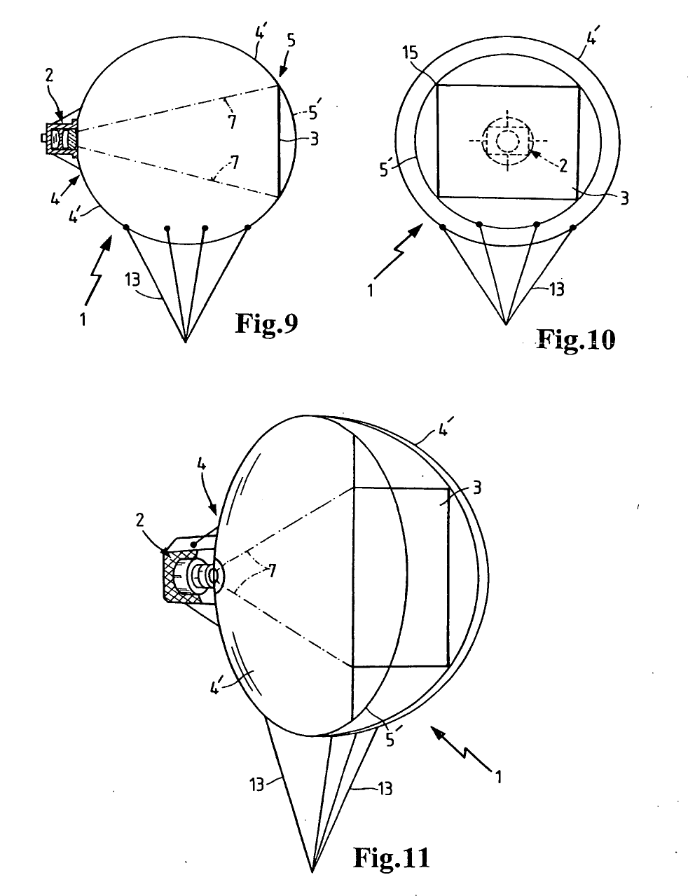

A first embodiment example of the second form of the invention will be described below, based on the various, schematic views depicted in FIGS. 9-11. The image projection device capable of hovering and flying comprises at least one buoyant body 1, projector 2, and projection surface 3. FIG. 9 depicts a schematic side view of the first embodiment example of the invention, a buoyant body 1 having a spherical shape, together with a projector 2 and a projection surface 3. This first embodiment example of the invention is schematically depicted in the front view, i.e., as viewed facing the projection surface 3, thereof shown in FIG. 10. Finally, FIG. 11 depicts a schematic perspective view of one-half of the first embodiment example of the invention shown in FIGS. 9 and 10. According to the second form of the invention, the volume of the buoyant body 1 is configured such that the buoyancy that it is capable of generating will allow stable locations of the projector 2 and projection surface 3, which are mutually remotely arranged at a separation corresponding to the projection range, where the projector 2 is arranged essentially outside a first outer surface 4. According to this embodiment example, that outer surface 4 is formed by the spherical surface of the skin 4′ of the spherical buoyant body 1. The projection surface 3 is essentially planar when in use. Furthermore, the projection surface 3 is arranged in the vicinity of a second outer surface 5 that is situated essentially across from the vicinity of the first outer surface 4 of the spherical buoyant body 1. Moreover, the projection surface 3 is fastened inside the buoyant body 1 as a separate component thereof, preferably by welding the corners 15 of the, for example, rectangular, projection surface 3 to its skin 4′.

The buoyant body 1 has a transparent, domed section 5′ in front of the projection surface 3 in order that images projected onto the projection surface 3 will be visible from outside that domed section 5′ of the skin of the buoyant body 1. The remainder of its skin 4′ is preferably opaque in order that stray light emanating from the beam path 7, which is indicated by the dotted lines in FIGS. 1 and 3, will not interfere with viewing of the projection surface 3.

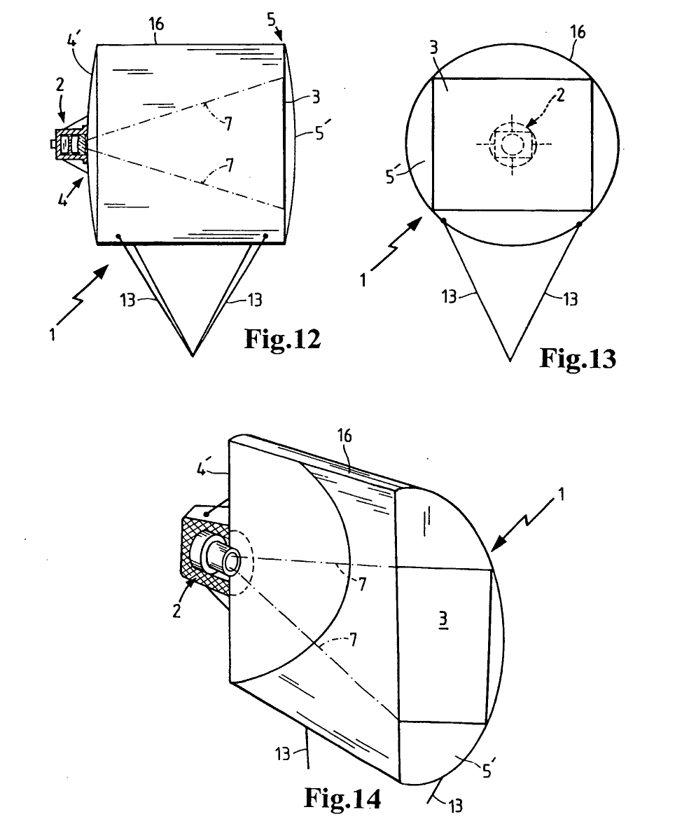

A second embodiment of the second form of the invention will be described below, based on those views depicted in FIGS. 12-14. FIG. 12 depicts a schematic side view of that second embodiment example of the second form of the invention, a buoyant body 1 in the form of a cylinder 16, together with a projector 2 and a projection surface 3. FIG. 13 depicts a schematic front view of the second embodiment example of the invention shown in FIG. 12, as viewed facing the projector 2, and FIG. 14 depicts a schematic perspective view of one-half of the second embodiment example of the invention shown in FIGS. 12 and 13. The buoyant body 1 is configured in the form of a cylinder 16. Once again, the projector 2 is mounted essentially outside a planar surface 4′ of the cylinder 16, and the projection surface 3 is mounted in the beam path 7, across from the projector 2, in the vicinity of the second, planar surface 5′ of the cylinder 16, which is essentially parallel to the first, as a separate component of the cylinder 16.

The projection surface 3 may be fastened to the wall of the cylinder 16, as a separate component thereof, in that vicinity 5. The projection surface 3 may also be incorporated into the associated, essentially planar, outer surface 5′ of the buoyant body 1. The buoyant body 1 is configured such that it is transparent over that section 5′ thereof that, when viewed from outside, is situated in front of the projection surface 3, if the projection surface is a separate component that has been incorporated into the cylinder 16. Alternatively, the projection surface 3 may also form the entire second, planar surface 5′ of the cylinder 16, or a portion thereof. The slight curvature of that surface will not, however, adversely affect the qualities of projected images, since the surface will still be essentially planar. Although the cylinder 16 depicted in FIGS. 12-14 is a right circular cylinder, the cylindrical buoyant body 1 may also be configured in the form of an oblique circular cylinder.

Regardless of whether the buoyant body 1 is in the form of a sphere, as depicted in FIGS. 9-11, or in the form of a cylinder 16, as depicted in FIGS. 12-14, it will be beneficial if it consists of a single component and may be simply inflated using a valve device. Spherical, or cylindrical, buoyant bodies 1 exhibit extremely high shape-stabilities once they have been inflated on site. Flexible lines 13 attached thereto keep the buoyant body 1, and thus the image projection device capable of hovering and flying according to the invention, floating in place, correctly positioned and oriented, at the desired altitude and location. The buoyant body 1 may thus be held in place using the flexible lines 13, which may be attached to cable anchorings on the ground, or to other fixed points within a room. The projection surface 3 may thus be simply oriented with respect to viewers and held in place in the desired manner.

Under another, beneficial configuration of the second form of the invention, controllable driving devices, in particular, driving devices that are controllable by a remote controller, which have not been shown in the figures, may also be provided on the buoyant body 1, which will allow both altering the positionings of projected images with respect to viewers and moving them from place to place.

The image projection devices capable of hovering and flying according to the invention make available facilities for projecting images under all conceivable circumstances and at any sort of location. Employing so-called “rear projection” will allow simultaneously supplying numerous viewers with information on large-area projections. The supply of signal information and power to the projector 2 may involve any known method employing cables, wireless transmission, or combinations thereof; the type of projection equipment employed may also be any known type thereof. The particular configuration employed allows achieving high degrees of attentiveness among viewers, while simultaneously solving, frequently difficult, problems related to ideal locations for such image projections. The invention this allows solving problems of economic interest in a beneficial manner employing simple means.

1-20. (canceled)

21. An image projection device that is capable of floating and flying, the device comprising:
a buoyant body having a first outer surface, a second outer surface opposite from the first outer surface, and a buoyancy-free section between the first and second outer surfaces, the second outer surface being substantially planar;
a projection screen arranged essentially at the second outer surface; and
a projector arranged essentially on the first outer surface of the buoyant body and being separated from the projection screen by a projection range which is within the buoyancy-free section;
wherein the buoyant body has a shape and a volume configured so that the buoyancy generated by the buoyant body provides stable locations of the projector and the projection surface.

22. The image projection device of claim 21 wherein the buoyancy-free section has one of a pyramidal and a conical shape.

23. The image projection device of claim 22 wherein the buoyant body is a single component having a cubical shape.

24. The image projection device of claim 21 wherein the buoyant body consists of two substantially identical partial bodies arranged one above the other.

25. The image projection device of claim 24 wherein the partial bodies are wedge-shaped.

26. The image projection device as in claim 24 wherein the partial bodies are joined together to form a buoyant body having a substantially cubical shape.

27. The image projection device of claim 21 wherein the buoyant body comprises individual chambers which are joined together to obtain a desired shape of the buoyant body.

28. An image projection device that is capable of floating and flying, the device comprising:
a buoyant body having a first outer surface, and a second outer surface opposite from the first outer surface;
a projection screen fastened to the buoyant body as a separate component in the vicinity of the second outer surface; and
a projector arranged essentially on the first outer surface of the buoyant body and being separated from the projection screen by a projection range;
wherein the buoyant body has a volume configured so that the buoyancy generated by the buoyant body provides stable locations of the projector and the projection surface.

29. The image projection device of claim 28 wherein the buoyant body has spherical shape and the projection screen has the shape of a spherical segment within the spherical body.

30. The image projection device of claim 29 wherein the buoyant body is transparent over the projection screen.

31. The image projection device of claim 28 wherein the buoyant body has a cylindrical shape with substantially planar first and second outer surfaces.

32. The image projection device of claim 31 wherein the projection screen is incorporated in the second outer surface.

33. The image projection device of claim 31 wherein the second outer surface is transparent over the projection screen.

34. The image projection device of claim 31 wherein the projection screen extends over the entire of the second outer surface.

35. The image projection device of claim 31 wherein buoyant body is configured substantially as a right circular cylinder.

36. The image projection device of claim 31 wherein the projection screen is welded in place inside the buoyant body.

37. The image projection device of claim 31 further comprising guy lines for holding the buoyant body in a floating position.

38. The image projection device of claim 31 wherein the device is wholly incorporated into one of a blimp and a dirigible.

39. The image projection device of claim 21 further comprising guy lines for holding the buoyant body in a floating position.

40. The image projection device of claim 21 wherein the device is wholly incorporated into one of a blimp and a dirigible.
